(19) United States
(12) Patent Application Publication
(10) Pub. No.: US 2025/0026980 A1
(43) Pub. Date: Jan. 23, 2025

(54) PREPARATION METHOD OF INDIUM PHOSPHIDE QUANTUM DOT (InP QD) WITH LARGE STOKES SHIFT

(71) Applicants: SHANGHAI JIAO TONG UNIVERSITY, Shanghai (CN); ZHEJIANG ORIENTAL GENE BIOLOGICAL PRODUCTS CO., LTD, Huzhou (CN)

(72) Inventors: Wanwan LI, Shanghai (CN); Lechen LI, Shanghai (CN); Zhiwen YANG, Shanghai (CN); Jianqiu FANG, Huzhou (CN)

(73) Assignees: SHANGHAI JIAO TONG UNIVERSITY, Shanghai (CN); ZHEJIANG ORIENTAL GENE BIOLOGICAL PRODUCTS CO., LTD, Huzhou (CN)

(21) Appl. No.: 18/716,160

(22) PCT Filed: Sep. 29, 2022
(86) PCT No.: PCT/CN2022/122460

§ 371 Date: Jun. 4, 2024

(30) Foreign Application Priority Data
Dec. 6, 2021 (CN) 202111481449.0

(51) Int. Cl. C09K 11/62

(52) U.S. Cl. CPC C09K 11/623

(57) ABSTRACT

A preparation method of an indium phosphide quantum dot (InP QD) with a large Stokes shift includes: fully dissolving the indium precursor at a first temperature under isolation from oxygen and water, adding a phosphorus precursor, and heating to a second temperature to allow a reaction to obtain an indium phosphide (InP) core; adding a shell precursor to the InP core, and heating to a third temperature to obtain QD with a core-shell structure; and adding anionic and cationic precursors successively to the QD with the core-shell structure at the third temperature to obtain the InP QD with an emission peak adjustable in a range of 465 nm to 650 nm, a high quantum efficiency, and a large Stokes shift. The InP QD mainly has a large Stokes shift to inhibit self-absorption and non-radiative resonance energy transfer.

### CROSS REFERENCE TO THE RELATED APPLICATIONS

This application is the national phase entry of International Application No. PCT/CN2022/122460, filed on Sep. 29, 2022, which is based upon and claims priority to Chinese Patent Application No. 202111481449.0, filed on Dec. 6, 2021, the entire contents of which are incorporated herein by reference.

### TECHNICAL FIELD

The present disclosure belongs to the field of quantum dot (QD) materials, and specifically relates to a preparation method of an indium phosphide quantum dot (InP QD) with a large Stokes shift.

### BACKGROUND

As a class of novel semiconductor nanomaterials, quantum dots (QDs) have characteristics such as a high quantum yield, a small full width at half maximum, excellent photochemical stability, and an adjustable wavelength due to a quantum size effect and a quantum confinement effect. Therefore, the QDs are widely used in technical fields such as QD display, white light-emitting devices (LEDs), solar concentrators, biological fluorescent labeling, and liquid-phase chips. However, the QDs currently in use include heavy metal elements such as cadmium or lead, and the toxicity of these elements limits the extensive application of the QDs. Indium phosphide (InP) has similar optical properties to cadmium or lead QDs, but does not include heavy metal elements and has little impact on the ecological environment and human health. Thus, InP can be used as a desired alternative material for cadmium QDs.

The preparation process for InP core-shell QDs in the prior art is relatively mature, and QDs produced by the preparation process can have comparable performance to cadmium QDs. Although the reported quantum yields of InP QDs are close to 100% at most, due to the spectral overlap between QDs of different luminescence wavelengths, there will be phenomena such as fluorescence resonance energy transfer (FRET) and reabsorption in practical applications, resulting in performance degradation. Specifically, in white LEDs, white light is often produced by mixing red, green and blue lights, but the FRET and reabsorption caused by the spectral overlap between QDs of different colors make it difficult to obtain a white LED with close chromaticity coordinates to pure white light, a high color rendering index, and a low color temperature value. In addition, when fluorescence-encoded microspheres are used for multiplexing, there is a non-orthogonal relationship between fluorescence signals of a microsphere and a luminescent material, which increases the complexity and difficulty of encoding library construction and limits the encoding number.

Currently, there are the following two methods to solve the energy transfer and reabsorption problems: 1) A distance between different luminescent materials is controlled. Some researchers eliminate the energy transfer by coating a surface with a polymer, which makes a preparation process complicated. 2) A luminescent material without spectral overlap is adopted. Some researchers provide a large Stokes shift by doping a transition metal ion and changing a structural morphology of QDs to eliminate the energy transfer. However, QDs prepared by the above methods all have a relatively-low luminescence efficiency.

Therefore, those skilled in the art are committed to the development of InP QD with a large Stokes shift and a preparation method thereof, so as to obtain InP QD with an adjustable emission wavelength, a high luminescence efficiency, a small full width at half maximum, and no energy transfer.

### SUMMARY

An objective of the present disclosure is to provide a preparation method of InP QD with a large Stokes shift in view of the above technical problems. In order to solve the problems in the prior art, an objective of the present disclosure is to optimize a synthesis method of an InP core-shell structure, so as to prepare InP QD with a large Stokes shift and effectively-inhibited FRET and allow the adjustable luminescence in a visible light range.

The objective of the present disclosure can be allowed by the following solutions:

An embodiment of the present disclosure provides a preparation method of InP QD with a large Stokes shift, including the following steps:
S1: mixing an indium precursor, a zinc precursor, and a coordination solvent to obtain an indium and zinc precursor solution;
S2: controlling the indium and zinc precursor solution obtained in the S1 to a first temperature, adding a phosphorus precursor, and heating to a second temperature and holding the second temperature to obtain an InP core solution, where the first temperature is 50° C. to 80° C. and the second temperature is 150° C. to 180° C.;
S3: adding a shell precursor to the InP core solution obtained in the S2, and heating to a third temperature and holding the third temperature to obtain an InP QD solution with an intermediate shell, where the third temperature is 290° C. to 320° C.; and
S4: adding an anionic precursor and a cationic precursor successively to the InP QD solution obtained in the S3, and holding the third temperature to obtain the InP QD with the intermediate shell, an outer shell and a large Stokes shift.

As an embodiment of the present disclosure, in the S1, after the indium precursor, the zinc precursor and the coordination solvent are mixed, a protective gas is introduced, a preliminary heating is conducted, and vacuum-pumping is conducted; then a second heating is conducted, and the temperature is held; sequentially, the protective gas is introduced, and a third heating is conducted to obtain the indium and zinc precursor solution, where the protective gas is one or more of a rare gas and nitrogen; the temperature for the preliminary heating is 100° C.; the temperature for the second heating is 120° C. to 140° C. and held for 1 h to 2 h; and the temperature for the third heating is 200° C. The introduction of the protective gas and the vacuum-pumping after the indium precursor, the zinc precursor and the coordination solvent are mixed can remove water and oxygen. This is because an InP core has a strong covalent character and is prone to a surface oxide layer in an aerobic environment, which is not conducive to the further shell coating and will make a luminescence efficiency reduced. If the vacuum-pumping is started at 120° C., bumping will occur, and a solution may be sucked into a gas path of a device. The heat preservation can ensure the full dissolution of the precursors. The rise to 200° C. in the protective atmosphere is intended to ensure the complete dissolution to obtain a clear and stable cationic precursor solution. The subsequent operations all are conducted in the protective atmosphere.

As an embodiment of the present disclosure, in the S2, the second temperature is held for 10 min to 150 min; in the S3, the third temperature is held for 0 min to 60 min; and in the S4, the third temperature is held for 0 min to 60 min. In the S3, the third temperature is preferably held for 5 min to 60 min; and in the S4, the third temperature is preferably held for 5 min to 60 min. During a heat preservation process, a shell grows on the InP core, and a heat preservation time affects the integrity of shell growth. For example, the intermediate shell ZnS has the optimal QD efficiency and full width at half maximum values when the heat preservation is conducted for 20 min. Because the phosphorus precursor has a high activity and starts to undergo a nucleation reaction at about 140° C., a temperature for InP nucleation during the heat-up method, namely, the second temperature, is controlled at 150° C. to 180° C., which corresponds to the optimal temperature for different zinc halides to produce QDs with different luminescence wavelengths. In the heat-up method, an InP QD core is mainly produced through the transformation of magic-sized clusters produced during a heating process. If the temperature is too high, for example, a reaction is generally conducted at 230° C. to 280° C. during the conventional hot-injection method, QDs produced have poor particle size uniformity. When a growth temperature of ZnS is at 300° C., InP/ZnS QD with the optimal quantum efficiency and full width at half maximum can be obtained. ZnSe has a higher optimal reaction temperature than ZnS, and thus a ZnSeS shell produced at 320° C. has the optimal quantum efficiency and full width at half maximum.

As an embodiment of the present disclosure, in the S1, a molar ratio of the zinc precursor to the indium precursor is (4.89-6.47):1; and in the S2, a molar ratio of the phosphorus precursor to the indium precursor is (5.6-7.4):1.

As an embodiment of the present disclosure, in the S1, the indium precursor is indium trichloride and the zinc precursor is one or more of zinc halides; and in the S2, the phosphorus precursor is tris(dimethylamino)phosphine.

As an embodiment of the present disclosure, in the S1, the coordination solvent is oleylamine.

As an embodiment of the present disclosure, in the S3, the shell anionic precursor includes one or more of octyl mercaptan, dodecyl mercaptan, sulfur/trioctylphosphine (S/TOP), sulfur/oleylamine (S/OAm), and selenium/trioctylphosphine (Se/TOP). A molar ratio of the shell anionic precursor to the zinc precursor is (1-2):1. Because QD produced with zinc chloride as a precursor has an emission wavelength of 580 nm and a spectrum of QD produced after further heating is seriously broadened, an intermediate layer structure is adjusted to prepare QD that has excellent comprehensive performance and is in a red light range. The growth of the ZnSeS shell promotes the redshift of a luminescence wavelength of QD. A high S content is conducive to the particle size uniformity, the reduction of a full width at half maximum of an emission spectrum, and the improvement of a quantum efficiency. When Se:(Se+S)=0.5, an interfacial stress between the InP core and the ZnS shell can be alleviated to obtain QD with an appropriate full width at half maximum and quantum efficiency.

As an embodiment of the present disclosure, in the S4, the anionic precursor is S/TOP, and the cationic precursor is zinc/oleylamine. A molar ratio of the anionic precursor to the cationic precursor is 1:(1-2).

As an embodiment of the present disclosure, the InP QD includes an InP core, an intermediate shell, and an outer shell; the intermediate shell is a ZnSeₓS₁₋ₓ shell, where X is in a value range of 0 to 1; the outer shell is a ZnS shell; and the outer shell covers the intermediate shell. When X=1, it is an InP/ZnSe/ZnS structure, and an efficiency is low. When X=0.5, a Stokes shift is large and an efficiency is high. Therefore, X is set to 0 to 1. X is preferably 0 to 0.8 and more preferably 0 to 0.5. The InP QD prepared by the present disclosure has a high quantum efficiency and a large Stokes shift. The intermediate shell is provided mainly to eliminate surface defects of InP and improve a quantum efficiency. A surface of InP is subjected to in-situ passivation using octyl mercaptan with a low activity to eliminate surface defects and improve a quantum yield; and then ZnS is allowed to uniformly grow in an outer layer through S/TOP with a moderate activity to produce a thick outer shell. The thick outer shell is mainly designed to produce a large Stokes shift.

As an embodiment of the present disclosure, the InP QD has an average size of 9 nm to 14 nm.

As an embodiment of the present disclosure, the InP QD has an emission peak at 460 nm to 650 nm and a full width at half maximum of less than 70 nm. The InP QD prepared by the present disclosure has a high quantum efficiency and a large Stokes shift.

In the present disclosure, QD cores with a uniform particle size is prepared through heating nucleation, which is conducive to the subsequent uniform growth of shells. Zinc/oleylamine and S/TOP (Se+S/TOP) are adopted as a shell precursor, which has a moderate reactivity. Sufficient amounts of anionic and cationic precursors are added, such that a thick passivation layer can uniformly grow at a periphery of an InP core, which can inhibit the energy transfer while improving a quantum efficiency.

The present disclosure mainly focuses on the realization of a large Stokes shift, and optimizes a cladding process to obtain QD with a high quantum efficiency and a uniform, perfect, and thick shell. The QD prepared by the present disclosure has an average size of 9 nm to 14 nm, and can effectively inhibit the energy transfer, which has been verified in the absorption-emission spectrum and energy transfer experiments. There is no such presentation with regard to this aspect in the prior art.

### BRIEF DESCRIPTION OF THE DRAWINGS

Other features, objectives, and advantages of the present disclosure will become apparent by reading the detailed description of non-limiting embodiments with reference to the following accompanying drawings.

The concept, structure, and technical effects of the present disclosure will be further described below in conjunction with the accompanying drawings.

FIG. 1 shows fluorescence emission spectra and ultraviolet-visible absorption spectra of InP core-shell QDs in Examples 1 to 5 of the present disclosure;

FIGS. 2A-2E show transmission electron microscopy (TEM) images of InP QDs in Examples 1 to 5 of the present disclosure, where FIG. 2A is a TEM image of QD with a luminescence wavelength of 465 nm in Example 1; FIG. 2B is a TEM image of QD with a luminescence wavelength of 512 nm in Example 2; FIG. 2C is a TEM image of QD with a luminescence wavelength of 580 nm in Example 3; FIG. 2D is a TEM image of QD with a luminescence wavelength of 635 nm in Example 4; and FIG. 2E is a TEM image of QD with a luminescence wavelength of 650 nm in Example 5;

FIGS. 3A-3D show fluorescence spectrum changes before and after mixing in a solution in Examples 2 and 4 of the present disclosure, where FIGS. 3A-3C show fluorescence spectra of QD solutions with different concentrations before and after mixing and FIG. 3D shows fluorescence intensity changes of three experiments;

FIGS. 4A-4B show spectra and a morphology image of InP QD prepared in Comparative Example 1 of the present disclosure, where FIG. 4A shows a fluorescence emission spectrum and an ultraviolet-visible absorption spectrum and FIG. 4B shows a TEM image; and

FIGS. 5A-5B shows spectra and a morphology image of InP QD prepared in Comparative Example 2 of the present disclosure, where FIG. 5A shows a fluorescence emission spectrum and an ultraviolet-visible absorption spectrum and FIG. 5B shows a TEM image.

### DETAILED DESCRIPTION OF THE EMBODIMENTS

In order to make the features and advantages of the present disclosure easy to understand, the technical solutions will be described in detail below in combination with the specific embodiments of the present disclosure. The described embodiments are merely some embodiments of the present disclosure, and the protection scope of the present disclosure includes, but is not limited to, the embodiments mentioned herein.

### Example 1

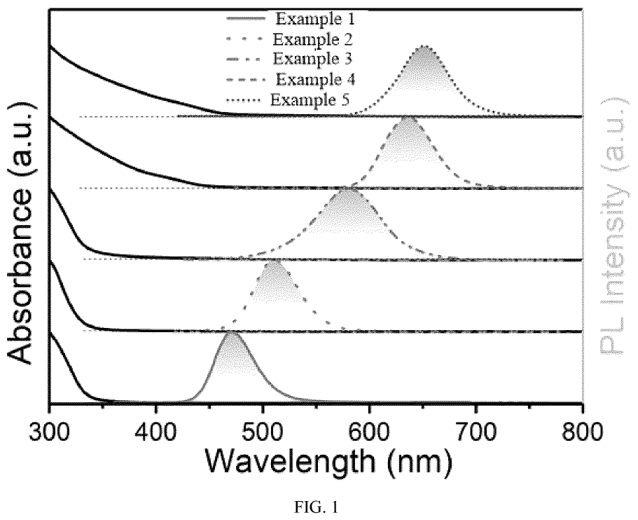

In this example, nitrogen was adopted as a protective gas, indium trichloride and tris(dimethylamino)phosphine were adopted as core precursors, and oleylamine was adopted as a coordination solvent to synthesize an InP core; then zinc iodide and octyl mercaptan were adopted as shell precursors to coat an InP/ZnS core-shell structure to improve a luminescence efficiency; and finally zinc iodide and S/TOP were adopted as precursors to further coat a shell, so as to prepare InP/ZnS/ZnS QD. As shown in FIG. 1, the QD had a fluorescence emission peak at 465 nm, a full width at half maximum of 39 nm, a quantum efficiency of 92%, and a large Stokes shift, which could effectively inhibit the energy transfer and reabsorption. Specific steps were as follows:

(1) Precursor preparation: 0.34 mmol of indium trichloride, 2.2 mmol of zinc iodide, and 5 mL of oleylamine were added to a 25 mL flask and heated to 100° C. in a protective gas atmosphere, then the flask was vacuumed and heated to 120° C. and kept at 120° C. for 90 min, then nitrogen was introduced, and the flask was heated to 200° C. to obtain a homogeneous and stable cationic precursor.

(2) Nucleation: A precursor solution obtained above was cooled to 60° C. to 70° C., a phosphorus precursor (which was produced by ultrasonically mixing 0.45 mL of tris(dimethylamino)phosphine with 1 mL of oleylamine) was added, and a resulting system was heated to 150° C. and kept at 150° C. for 150 min to allow a reaction to obtain an InP QD core.

(3) First shell coating: 0.44 mL of octyl mercaptan was slowly added to a solution obtained above, and a resulting system was heated to 300° C. and kept at 300° C. for 20 min, such that a uniform ZnS shell was gradually formed on a surface of an InP core from the monomer to obtain an InP/ZnS core-shell structure.

(4) Second shell coating: S/TOP (which was produced by ultrasonically dispersing 4 mmol of an S powder in 2 mL of TOP for about 10 min to obtain a completely-clear solution) prepared in advance was added to a solution obtained above, then a zinc/oleylamine precursor (which was produced by dissolving 4.4 mol of zinc iodide in 5 mL of oleylamine) was slowly added, and a reaction was conducted at 300° C. for 40 min to form a thick ZnS shell.

(5) Purification: A solution produced at the end of the reaction was cooled to room temperature, then chloroform and ethanol were added proportionally, and a resulting system was centrifuged to obtain a precipitate; the precipitate was dispersed with chloroform, ethanol was added in the same proportion, and a resulting system was centrifuged to obtain a precipitate; and the precipitate was finally dissolved in toluene to obtain purified InP/ZnS/ZnS QD with a large Stokes shift.

### Example 2

In this example, nitrogen was adopted as a protective gas, indium trichloride and tris(dimethylamino)phosphine were adopted as core precursors, and oleylamine was adopted as a coordination solvent to synthesize an InP core; then zinc bromide and octyl mercaptan were adopted as shell precursors to coat an InP/ZnS core-shell structure to improve a luminescence efficiency; and finally zinc bromide and S/TOP were adopted as precursors to further coat a shell, so as to prepare InP/ZnS/ZnS QD. As shown in FIG. 1, the QD had a fluorescence emission peak at 512 nm, a full width at half maximum of 48 nm, a quantum efficiency of higher than 90%, and a large Stokes shift, which could effectively inhibit the energy transfer and reabsorption. Specific steps were as follows:

(1) Precursor preparation: 0.34 mmol of indium trichloride, 2.2 mmol of zinc bromide, and 5 mL of oleylamine were added to a 25 mL flask and heated to 100° C. in a protective gas atmosphere, then the flask was vacuumed and heated to 120° C. and kept at 120° C. for 90 min, then nitrogen was introduced, and the flask was heated to 200° C. to obtain a homogeneous and stable cationic precursor.

(2) Nucleation: A precursor solution obtained above was cooled to 60° C. to 70° C., a phosphorus precursor (which was produced by ultrasonically mixing 0.45 mL of tris(dimethylamino)phosphine with 1 mL of oleylamine) was added, and a resulting system was heated to 160° C. and kept at 160° C. for 15 min to allow a reaction to obtain an InP QD core.

(3) First shell coating: 0.44 mL of octyl mercaptan was slowly added to a solution obtained above, and a resulting system was heated to 300° C. and kept at 300° C. for 20 min, such that a uniform ZnS shell was gradually formed on a surface of an InP core from the monomer to obtain an InP/ZnS core-shell structure.

(4) Second shell coating: S/TOP (which was produced by ultrasonically dispersing 4 mmol of an S powder in 2 mL of TOP for about 10 min to obtain a completely-clear solution) prepared in advance was added to a solution obtained above, then a zinc/oleylamine precursor (which was produced by dissolving 4.4 mmol of zinc bromide in 5 mL of oleylamine) was slowly added, and a reaction was conducted at 300° C. for 40 min to form a thick ZnS shell.

(5) Purification: A solution produced at the end of the reaction was cooled to room temperature, then chloroform and ethanol were added proportionally, and a resulting system was centrifuged to obtain a precipitate; the precipitate was dispersed with chloroform, ethanol was added in the same proportion, and a resulting system was centrifuged to obtain a precipitate; and the precipitate was finally dissolved in toluene to obtain purified InP/ZnS/ZnS QD with a large Stokes shift.

### Example 3

In this example, nitrogen was adopted as a protective gas, indium trichloride and tris(dimethylamino)phosphine were adopted as core precursors, and oleylamine was adopted as a coordination solvent to synthesize an InP core; then zinc chloride and octyl mercaptan were adopted as shell precursors to coat an InP/ZnS core-shell structure to improve a luminescence efficiency; and finally zinc chloride and S/TOP were adopted as precursors to further coat a shell, so as to prepare InP/ZnS/ZnS QD. As shown in FIG. 1, the QD had a fluorescence emission peak at 580 nm, a full width at half maximum of 70 nm, a quantum efficiency of higher than 90%, and a large Stokes shift, which could effectively inhibit the energy transfer and reabsorption. Specific steps were as follows:

(1) Precursor preparation: 0.45 mmol of indium trichloride, 2.2 mmol of zinc chloride, and 5 mL of oleylamine were added to a 25 mL flask and heated to 100° C. in a protective gas atmosphere, then the flask was vacuumed and heated to 120° C. and kept at 120° C. for 90 min, then nitrogen was introduced, and the flask was heated to 200° C. to obtain a homogeneous and stable cationic precursor.

(2) Nucleation: A precursor solution obtained above was cooled to 60° C. to 70° C., a phosphorus precursor (which was produced by ultrasonically mixing 0.45 mL of tris(dimethylamino)phosphine with 1 mL of oleylamine) was added, and a resulting system was heated to 180° C. and kept at 180° C. for 20 min to allow a reaction to obtain an InP QD core.

(3) First shell coating: 0.44 mL of octyl mercaptan was slowly added to a solution obtained above, and a resulting system was heated to 300° C. and kept at 300° C. for 20 min, such that a uniform ZnS shell was gradually formed on a surface of an InP core from the monomer to obtain an InP/ZnS core-shell structure.

(4) Second shell coating: S/TOP (which was produced by ultrasonically dispersing 4 mmol of an S powder in 2 mL of TOP for about 10 min to obtain a completely-clear solution) prepared in advance was added to a solution obtained above, then a zinc/oleylamine precursor (which was produced by dissolving 4.4 mmol of zinc chloride in 5 mL of oleylamine) was slowly added, and a reaction was conducted at 300° C. for 40 min to form a thick ZnS shell.

(5) Purification: A solution produced at the end of the reaction was cooled to room temperature, then chloroform and ethanol were added proportionally, and a resulting system was centrifuged to obtain a precipitate; the precipitate was dispersed with chloroform, ethanol was added in the same proportion, and a resulting system was centrifuged to obtain a precipitate; and the precipitate was finally dissolved in toluene to obtain purified InP/ZnS/ZnS QD with a large Stokes shift.

### Example 4

In this example, nitrogen was adopted as a protective gas, indium trichloride and tris(dimethylamino)phosphine were adopted as core precursors, and oleylamine was adopted as a coordination solvent to synthesize an InP core; then zinc chloride and S—Se/TOP were adopted as shell precursors to coat an InP/ZnSeₓS₁₋ₓ core-shell structure to improve a luminescence efficiency; and finally zinc chloride and S/TOP were adopted as precursors to further coat a shell, so as to prepare InP/ZnSeₓS₁₋ₓ/ZnS QD. As shown in FIG. 1, the QD had a fluorescence emission peak at 635 nm, a full width at half maximum of 60 nm, a quantum efficiency of higher than 60%, and a large Stokes shift, which could effectively inhibit the energy transfer and reabsorption. Specific steps were as follows:

(1) Precursor preparation: 0.45 mmol of indium trichloride, 2.2 mmol of zinc chloride, and 5 mL of oleylamine were added to a 25 mL flask and heated to 100° C. in a protective gas atmosphere, then the flask was vacuumed and heated to 120° C. and kept at 120° C. for 90 min, then nitrogen was introduced, and the flask was heated to 200° C. to obtain a homogeneous and stable cationic precursor.

(2) Nucleation: A precursor solution obtained above was cooled to 60° C. to 70° C., a phosphorus precursor (which was produced by ultrasonically mixing 0.45 mL of tris(dimethylamino) phosphine with 1 mL of oleylamine) was added, and a resulting system was heated to 180° C. and kept at 180° C. for 20 min to allow a reaction to obtain an InP QD core.

(3) First shell coating: S—Se/TOP (which was produced by ultrasonically dispersing 1.1 mmol of an S powder and 1.1 mmol of a Se powder in 1.1 mL of TOP for about 10 min to obtain a completely-clear solution) was slowly added to a solution obtained above, and a resulting system was heated to 320° C. and kept at 320° C. for 20 min, such that a uniform ZnSeₓS₁₋ₓ shell was gradually formed on a surface of an InP core from the monomer to obtain an InP/ZnSeₓS₁₋ₓ core-shell structure.

(4) Second shell coating: S/TOP (which was produced by ultrasonically dispersing 4 mmol of an S powder in 2 mL of TOP for about 10 min to obtain a completely-clear solution) prepared in advance was added to a solution obtained above, then a zinc/oleylamine precursor (which was produced by dissolving 4.4 mmol of zinc chloride in 5 mL of oleylamine) was slowly added, and a reaction was conducted at 300° C. for 40 min to form a thick ZnS shell.

(5) Purification: A solution produced at the end of the reaction was cooled to room temperature, then chloroform and ethanol were added proportionally, and a resulting system was centrifuged to obtain a precipitate; the precipitate was dispersed with chloroform, ethanol was added in the same proportion, and a resulting system was centrifuged to obtain a precipitate; and the precipitate was finally dissolved in toluene to obtain purified InP/ZnSeₓS₁₋ₓ/ZnS QD with a large Stokes shift.

### Example 5

In this example, nitrogen was adopted as a protective gas, indium trichloride and tris(dimethylamino) phosphine were adopted as core precursors, and oleylamine was adopted as a coordination solvent to synthesize an InP core; then zinc chloride and Se/TOP were adopted as shell precursors to coat an InP/ZnSe core-shell structure to improve a luminescence efficiency; and finally zinc chloride and S/TOP were adopted as precursors to further coat a shell, so as to prepare InP/ZnSe/ZnS QD. As shown in FIG. 1, the QD had a fluorescence emission peak at 650 nm, a full width at half maximum of 54 nm, a quantum efficiency of 21%, and a large Stokes shift, which could effectively inhibit the energy transfer and reabsorption. Specific steps were as follows:

(1) Precursor preparation: 0.45 mmol of indium trichloride, 2.2 mmol of zinc chloride, and 5 mL of oleylamine were added to a 25 mL flask and heated to 100° C. in a protective gas atmosphere, then the flask was vacuumed and heated to 120° C. and kept at 120° C. for 90 min, then nitrogen was introduced, and the flask was heated to 200° C. to obtain a homogeneous and stable cationic precursor.

(2) Nucleation: A precursor solution obtained above was cooled to 60° C. to 70° C., a phosphorus precursor (which was produced by ultrasonically mixing 0.45 mL of tris(dimethylamino) phosphine with 1 mL of oleylamine) was added, and a resulting system was heated to 180° C. and kept at 180° C. for 20 min to allow a reaction to obtain an InP QD core.

(3) First shell coating: Se/TOP (which was produced by ultrasonically dispersing 2.2 mmol of a Se powder in 1.1 mL of TOP for about 10 min to obtain a completely-clear solution) was slowly added to a solution obtained above, and a resulting system was heated to 320° C. and kept at 320° C. for 20 min, such that a uniform ZnSe shell was gradually formed on a surface of an InP core from the monomer to obtain an InP/ZnSe core-shell structure.

(4) Second shell coating: S/TOP (which was produced by ultrasonically dispersing 4 mmol of an S powder in 2 mL of TOP for about 10 min to obtain a completely-clear solution) prepared in advance was added to a solution obtained above, then a zinc/oleylamine precursor (which was produced by dissolving 4.4 mmol of zinc chloride in 5 mL of oleylamine) was slowly added, and a reaction was conducted at 300° C. for 40 min to form a thick ZnS shell.

(5) Purification: A solution produced at the end of the reaction was cooled to room temperature, then chloroform and ethanol were added proportionally, and a resulting system was centrifuged to obtain a precipitate; the precipitate was dispersed with chloroform, ethanol was added in the same proportion, and a resulting system was centrifuged to obtain a precipitate; and the precipitate was finally dissolved in toluene to obtain purified InP/ZnSe/ZnS QD with a large Stokes shift.

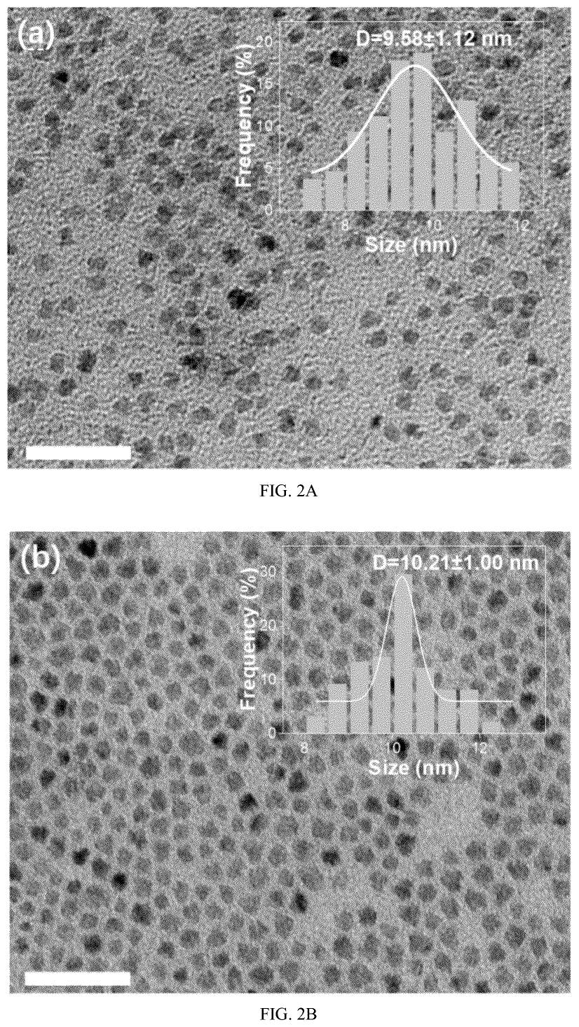

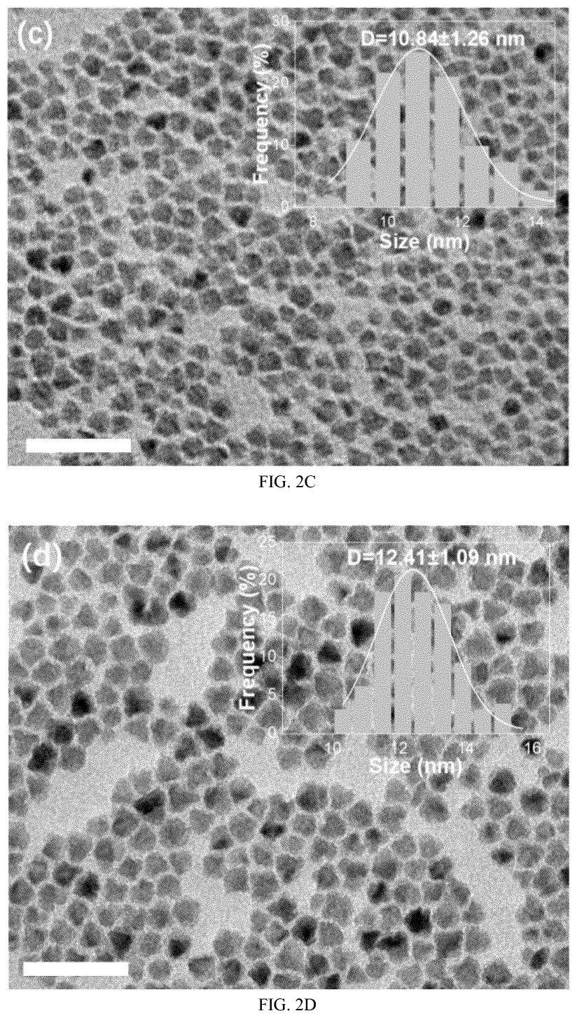

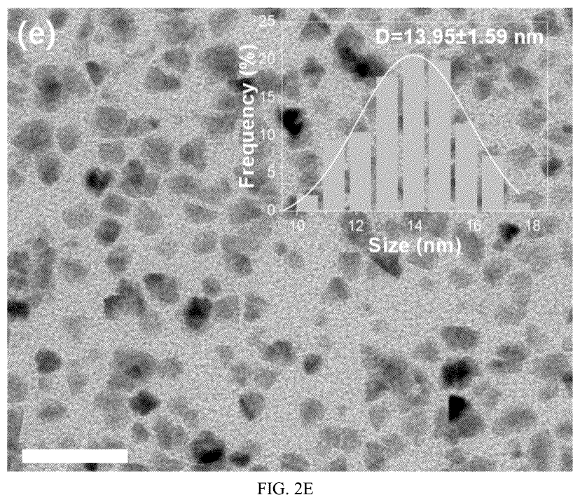

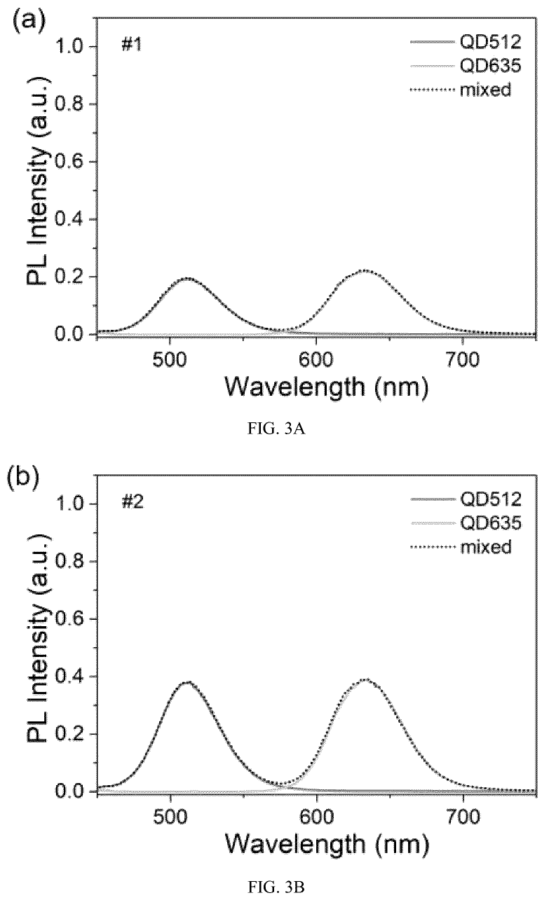

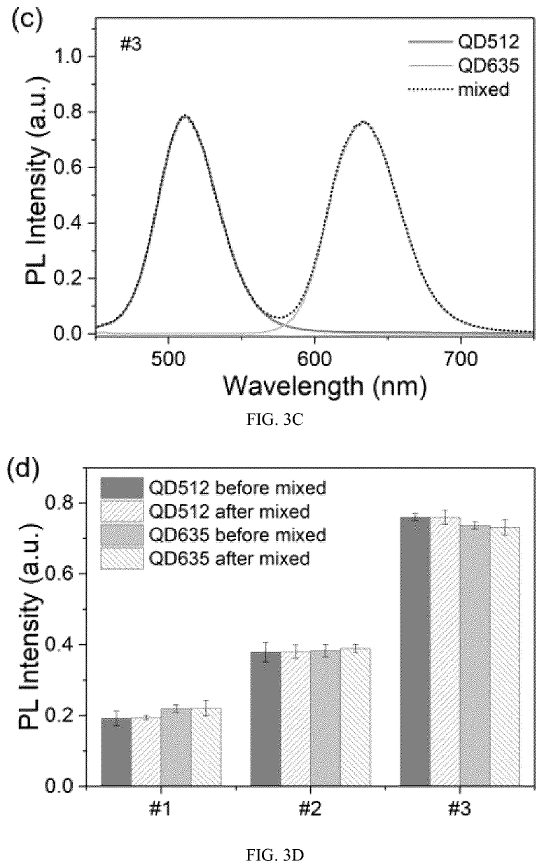

It can be seen from FIG. 1 that an emission wavelength of InP QD can be adjusted from 465 nm to 580 nm by adopting zinc precursors of different halogen elements, and the emission wavelength can be further adjusted to 650 nm by adding the intermediate shell ZnSeₓS₁₋ₓ. It can be seen from FIGS. 2A-2E that the prepared QDs all have a large particle size of about 10 nm. It can be seen from FIGS. 3A-3D that, because the prepared QDs have a large Stokes shift characteristic, the QDs obtained in Examples 2 and 4 are mixed, and a fluorescence spectrum is basically unchanged before and after mixing, indicating that the QD developed by the present disclosure can solve the problems of reabsorption and energy transfer between QDs.

### Comparative Example 1

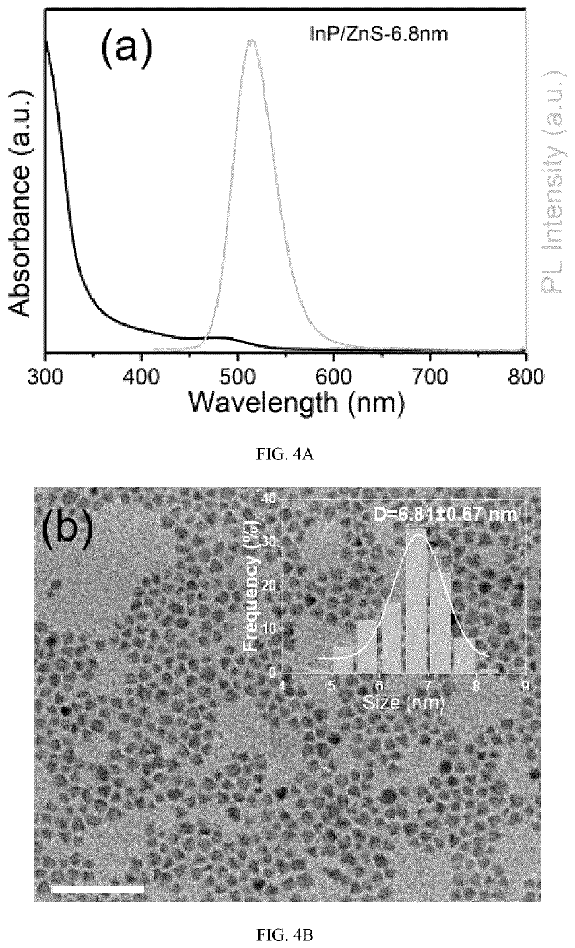

The preparation method in this comparative example was similar to the preparation method in Example 2, except that the second shell was not coated. FIGS. 4A-4B show a fluorescence emission spectrum and an ultraviolet-visible absorption spectrum and a TEM image of the InP QD prepared in this comparative example.

### Test and Analysis:

It can be seen from FIGS. 4A-4B that the QD has a luminescence peak at 512 nm and an average particle size of 6.81 nm. When the second shell is not coated, the QD prepared does not have a large Stokes shift.

### Comparative Example 2

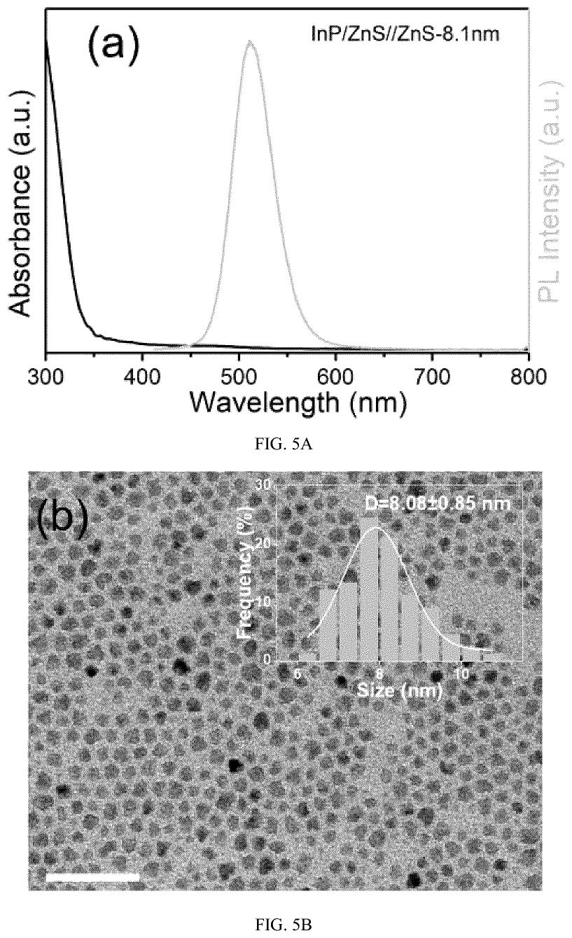

The preparation method in this comparative example was similar to the preparation method in Example 2, except that the precursors for the second shell were added at an amount ½ of the amount in Example 2. FIGS. 5A-5B show a fluorescence emission spectrum and an ultraviolet-visible absorption spectrum and a TEM image of the InP QD prepared in this comparative example.

### Test and Analysis:

The InP QD prepared by the method in this comparative example was tested and analyzed, and the QD had a luminescence peak at 512 nm and an average particle size of 8.08 nm. Obviously, when the amount of the shell precursor is halved compared with Example 2, the QD prepared does not have a large Stokes shift.

It can be seen from the data of Comparative Examples 2 and 3 and Example 2 that, through the step-by-step cladding process in Example 2, a thick ZnS shell is successfully coated on the InP core to obtain a large Stokes shift, which provides a new way for solving the problems of energy transfer and reabsorption.

Compared with the prior art, the present disclosure has the following beneficial effects:

1. By controlling the reaction temperatures, the reaction times, and the types and proportions of precursors, the growth of light-emitting cores of InP QDs and the coating thickness of the shell can be allowed to obtain QDs with a uniform particle size, a luminescence wavelength adjustable in a range of 465 nm to 650 nm, a quantum efficiency of higher than 90%, and a large Stokes shift.

2. The present disclosure adopts a technical route of heating nucleation, heating cladding, and hot-injection cladding, where crystal nuclei for InP QDs are prepared at a low first temperature, then an intermediate passivation layer is coated on a surface by heating to eliminate surface defects and improve a luminescence efficiency of QDs, and finally precursors are added at a third temperature to thicken the shell to improve the stability of QDs, increase a Stokes shift, and reduce the occurrence of energy transfer.

3. In the present disclosure, the nucleation and growth processes of InP QDs are controlled by a heat-up method, such that the QDs have a uniform particle size distribution and a small full width at half maximum. The high-temperature cladding can allow the formation of a thick passivation layer to further improve the optical properties of InP QDs. The preparation method of the present disclosure is simple, has a low cost and high repeatability, and provides a new method and idea for solving the problem of energy transfer.

The specific implementations of the present disclosure are described above. It should be understood that the present disclosure is not limited to the above specific implementations, and a person skilled in the art can make various variations or modifications within the scope of the claims without affecting the essence of the present disclosure.

What is claimed is:

1. A preparation method of an indium phosphide quantum dot (InP QD) with a large Stokes shift, comprising the following steps:
S1: mixing an indium precursor, a zinc precursor, and a coordination solvent to obtain an indium and zinc precursor solution;
S2: controlling the indium and zinc precursor solution obtained in the S1 to a first temperature, adding a phosphorus precursor, and heating to a second temperature and holding the second temperature to obtain an indium phosphide (InP) core solution, wherein the first temperature is 50° C. to 80° C. and the second temperature is 150° C. to 180° C.;
S3: adding a shell precursor to the InP core solution obtained in the S2, and heating to a third temperature and holding the third temperature to obtain an InP QD solution with an intermediate shell, wherein the third temperature is 290° C. to 320° C.; and
S4: adding an anionic precursor and a cationic precursor successively to the InP QD solution obtained in the S3, and holding the third temperature to obtain the InP QD with the intermediate shell, an outer shell and the large Stokes shift.

2. The preparation method of the InP QD according to claim 1, wherein in the S1, after the indium precursor, the zinc precursor and the coordination solvent are mixed, a protective gas is introduced, vacuum-pumping is conducted, and heating and heat preservation are conducted to obtain the indium and zinc precursor solution; the protective gas is one or more of a rare gas and nitrogen; and a temperature for the heating is 120° C. to 140° C. and a time for the heat preservation is 1 h to 2 h.

3. The preparation method of the InP QD according to claim 1, wherein in the S2, the second temperature is held for 10 min to 150 min; in the S3, the third temperature is held for 0 min to 60 min; and in the S4, the third temperature is held for 0 min to 60 min.

4. The preparation method of the InP QD according to claim 1, wherein in the S1, the indium precursor is indium trichloride and the zinc precursor is one or more of zinc halides; and in the S2, the phosphorus precursor is tris(dimethylamino) phosphine.

5. The preparation method of the InP QD according to claim 1, wherein in the S1, the coordination solvent is oleylamine.

6. The preparation method of the InP QD according to claim 1, wherein in the S3, the shell precursor comprises at least one selected from the group consisting of octyl mercaptan, dodecyl mercaptan, sulfur/trioctylphosphine (S/TOP), sulfur/oleylamine (S/OAm), and selenium/trioctylphosphine (Se/TOP).

7. The preparation method of the InP QD according to claim 1, wherein in the S4, the anionic precursor is S/TOP, and the cationic precursor is zinc/oleylamine.

8. The preparation method of the InP QD according to claim 1, wherein the intermediate shell is a ZnSeₓS₁₋ₓ shell, and X is in a value range of 0 to 1; the outer shell is a ZnS shell; and the outer shell covers the intermediate shell.

9. The preparation method of the InP QD according to claim 1, wherein the InP QD has an average size of 9 nm to 14 nm.

10. The preparation method of the InP QD according to claim 1, wherein the InP QD has an emission peak at 460 nm to 650 nm and a full width at half maximum of less than 70 nm.
